(19) United States
(12) Patent Application Publication
(10) Pub. No.: US 2013/0343580 A1
(43) Pub. Date: Dec. 26, 2013

(54) Back Plate Apparatus with Multiple Layers Having Non-Uniform Openings

(71) Applicant: Knowles Electronics, LLC, Itasca, IL (US)

(72) Inventors: Eric J. Lautenschlager, Geneva, IL (US); Peter V. Loeppert, Durand, IL (US)

(73) Assignee: Knowles Electronics, LLC, Itasca, IL (US)

(21) Appl. No.: 13/911,696

(22) Filed: Jun. 6, 2013

Related U.S. Application Data
(60) Provisional application No. 61/656,578, filed on Jun. 7, 2012.

(51) Int. Cl. H04R 1/00

(52) U.S. Cl. CPC H04R 1/00
USPC 381/174

(57) ABSTRACT

An acoustic microphone includes a back plate, a diaphragm, and a microelectromechanical system (MEMS) structure that is coupled to the back plate and the diaphragm. The MEMS structure is disposed on a substrate. The back plate includes a first layer and a second layer that are disposed in generally parallel relation to each other. The first layer including a first opening with a first sizing and the second layer including a second opening with a second sizing. The first sizing is different from the second sizing. The first opening and the second opening form a channel through the back plate.

### CROSS REFERENCE TO RELATED APPLICATION

This patent claims benefit under 35 U.S.C. §119 (e) to U.S. Provisional Application No. 61/656,578 entitled “Back plate apparatus with multiple layers having non-uniform openings” filed Jun. 7, 2012, the content of which is incorporated herein by reference in its entirety.

### TECHNICAL FIELD

This application relates to the acoustic devices and more specifically to the components that are used in these devices.

### BACKGROUND OF THE INVENTION

Various types of acoustic devices have been used over the years. One example of an acoustic device is a microphone and another example is a receiver. Generally speaking, a microphone picks up sound and converts the sound into an electrical signal while a receiver takes an electrical signal and converts the electrical signal into sound.

A microphone typically is constructed of different elements including a back plate and a diaphragm. The back plate and a diaphragm are generally disposed near each other. When the diaphragm is moved by sound energy, a charge at the back plate is created/altered and this, in turn, creates an electrical signal that is representative of the sound energy. The electrical signal can be further processed by other circuitry.

The back plate and a diaphragm are housed within a housing unit. One problem with previous microphones occurs when particulates or other debris enter the sensitive region between the back plate and a diaphragm or when the debris impacts the diaphragm. When either of these situations occurs, damage to the microphone may occur and the performance of the microphone may become degraded. Previous attempts at solving this problem have generally required the use of a separate screen, or mesh, to prevent debris from entering the sensitive region, but the introduction of this feature introduces other problems into the system. For instance, the performance of the microphone can be degraded due to increased acoustic resistance from the mesh, or the cost of the device may be increased due to the extra cost and processing required for using the mesh.

Another problem with the previous approach is the degradation of the signal to noise ratios of the device. Noise is one factor of the signal-to-noise ratio, which is a measure of how well the microphone can perform. Acoustic resistance is one factor which contributes to noise. In fact, it is desirable that the microphone have the highest signal-to-noise ratio possible because it is then when the microphone has the highest performance. Unfortunately, previous attempts to increase (or even maintain) the signal-to-noise ratio and/or prevent particle intrusion have had very limited success.

### BRIEF DESCRIPTION OF THE DRAWINGS

For a more complete understanding of the disclosure, reference should be made to the following detailed description and accompanying drawings wherein:

FIG. 1 comprises a cross sectional view of a top port microphone according to various embodiments of the present invention;

FIG. 2 comprises a cross sectional view of a bottom port microphone according to various embodiments of the present invention;

FIGS. 3A-D comprise cross sectional views of back plates according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are provided herein where microphone back plate structures are constructed with a plurality of layers and the layers have openings extending there through. The sizing of the openings for each layer is distinct from the size of the openings for the other layers and in some aspects this provides particle filtering capability. At the same time, the approaches provided herein minimize the noise impact that normally would be associated with small openings (e.g., shrinking the openings). In one aspect, the thinnest material layer of the back plate (a first layer) is constructed with the smallest opening constriction so as to provide particle or debris filtering. Other material layers (e.g., a second layer) are provided with wider openings to counter-act the noise increase from the smaller opening constriction in the first layer.

As provided by the approaches herein, particle or debris filtering improves the reliability of the device. However, using the small holes or openings for filtering somewhat reduces the microphone performance by increasing the acoustic resistance, and therefore, noise. Acoustic resistance is a function of the smallness of the hole diameter, and the thickness of the hole channel, or the distance the air must flow through. Using the non-uniform hole/opening profile structure provides an approach that minimizes the noise increase.

It will be understood that many of the examples described herein, the back plate has two layers. However, it will be appreciated that any number of layers (2 or more) may be used. It will also be appreciated that the openings in the back plate as described herein are circular holes, but that any shape of opening may be used.

An acoustic microphone includes a back plate, a diaphragm, and a microelectromechanical system (MEMS) structure that is coupled to the back plate and the diaphragm. The MEMS structure is disposed on a substrate. The back plate includes a first layer and a second layer that are disposed in generally parallel relation to each other. The first layer including a first opening with a first sizing and the second layer including a second opening with a second sizing. The first sizing is different from the second sizing. The first opening and the second opening form a channel through the back plate.

In some aspects, the back plate includes a third layer with a third opening. In other aspects, the first sizing includes a first diameter and the second sizing includes a second diameter, and the first diameter is less than the second diameter.

In some examples, the first layer and the second layer are constructed of a thin film material. The channel may be shaped in different ways. For instance, the channel may step shaped or funnel shaped. Other examples are possible.

In some examples, the microphone is a top port device. In still other examples, the microphone is a bottom port device.

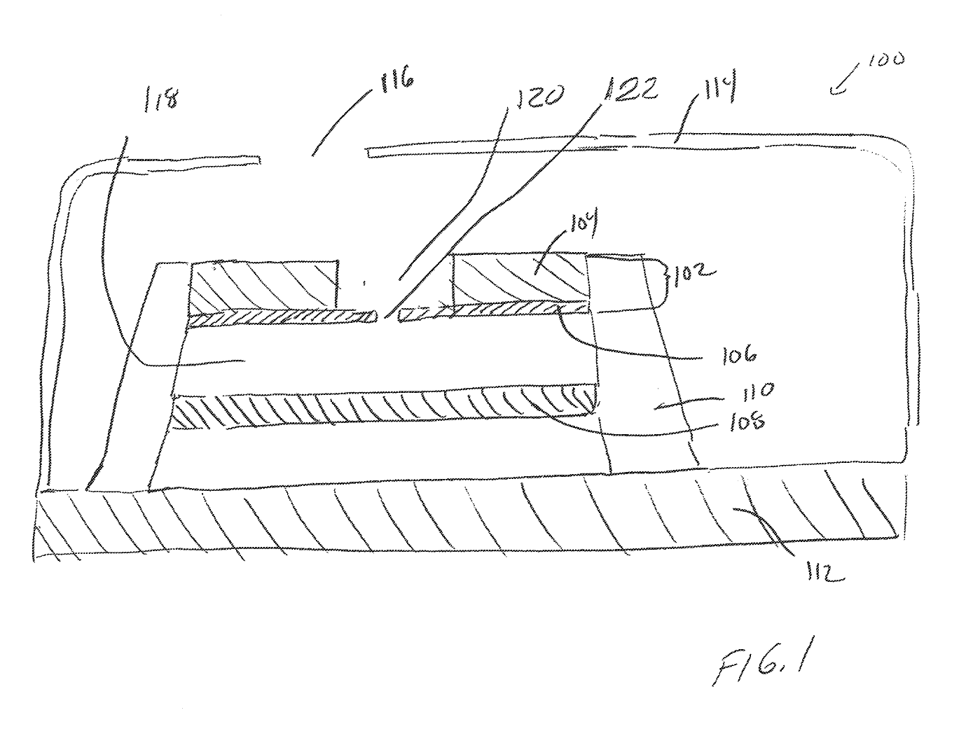

Referring now to FIG. 1, one example of a microphone or microphone assembly 100 (a top port microphone) is described. The microphone includes a back plate 102 (including a first layer 104 and a second layer 106), a diaphragm 108, a MEMS structure 110, a substrate 112, a housing 114, a port 116 (extending through the housing 114). A sensitive area 118 is formed and disposed between the back plate 102 and the diaphragm 108.

The first layer 104 includes a first opening 120 and the second layer 106 has a second opening 122. The second opening 122 is less in diameter than the first opening 120 such that particulates that might pass through the first opening 120 from the port 116, may not pass through the second opening 122 because the size of the particulate is greater than the size of the second opening 122. The first layer 104 and the second layer 106 are formed from any of a number of thin film materials, such as polysilicon, or silicon nitride. The second layer 106 is less in thickness than the first layer 104. In one example, the first layer is 1.4 um thick and the second layer 106 is 0.5 um thick. Other examples are possible.

The diaphragm 108 and MEMS structure 110 are elements that are well known to those skilled in the art and are not further described here. The output signal from the back plate 102 may be coupled to an integrated circuit (not shown) for further processing. The MEMS microphone 100 receives sound energy from the port 116, the sound energy (or changes in sound pressure) moves the diaphragm 108, this movement causes a change in charge of the back plate 102, which creates an electrical signal. The electrical signal may be transmitted to an integrated circuit or out of the microphone 100.

In one example of the operation of the system of FIG. 1, particulates pass through the port 116 and into the first opening 120, but cannot pass through the second opening 122. The smaller size of the second opening 122 may increase the acoustic resistance of the device which lowers the signal-to-noise ratio of the microphone 100. However, since the smaller opening 122 is placed only in the thinner layer 106, this increase in acoustic resistance is minimized. Consequently, a microphone 100 is provided that prevents debris from entering the sensitive region 118 or impacting the diaphragm 108, but the device 100 still has an adequate signal-to-noise ratio (e.g., 59 dBA). In other words, the lowering of the acoustic resistance is minimized while the particulate/debris is still removed.

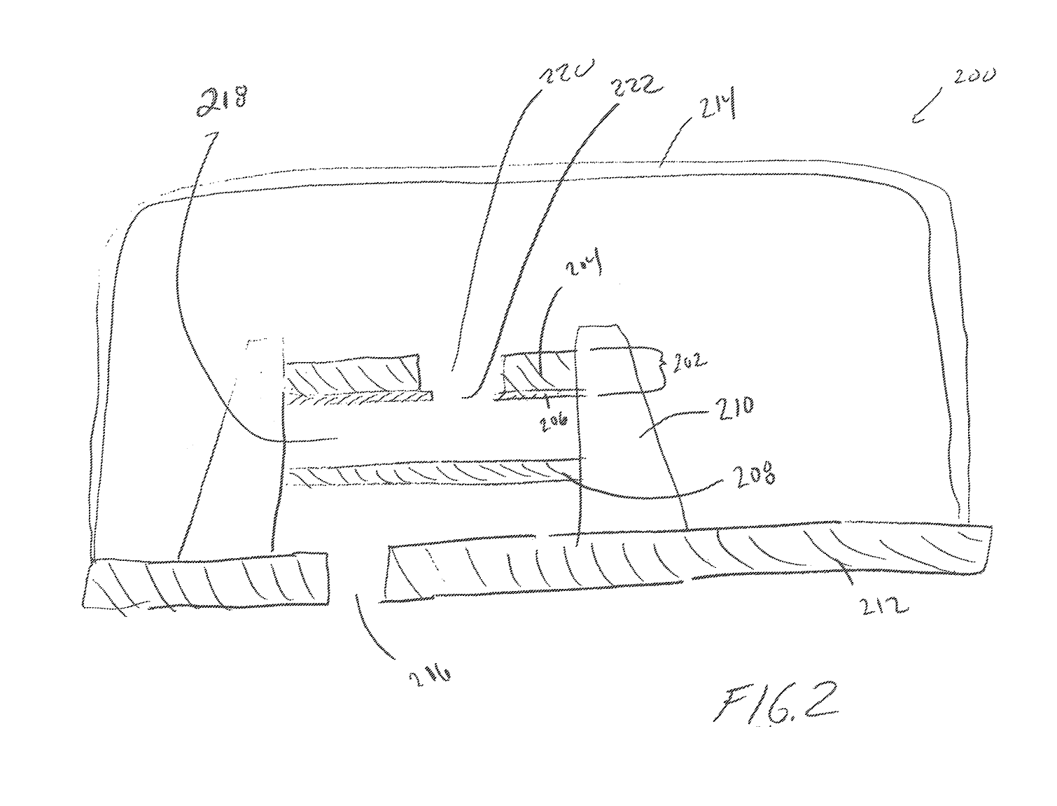

Referring now to FIG. 2, one example of a microphone or microphone assembly 200 (a bottom port microphone) is described. The microphone includes a back plate 202 (including a first layer 204 and a second layer 206), a diaphragm 208, a MEMS structure 210, a substrate 212, a housing 214, a port 216 (extending through the substrate 212). A sensitive area 218 is disposed between the back plate 102 and the diaphragm 208.

The first layer 204 includes a first opening 220 and the second layer 206 has a second opening 222. The second opening 222 is less in diameter than the first opening 220. In one aspect, the manufacturing process starts with (or is provided with) a fixed-sized opening 222, and then the size of the opening 220 is increased. The first layer 204 and the second layer 206 are constructed of any number of thin film materials, such as polysilicon, or silicon nitride. The second layer 206 is much less in thickness than the first layer 204. In one example, the first layer is 1.4 um thick and the second layer 206 is 0.5 um thick. Other examples are possible.

The diaphragm 208 and MEMS structure 210 are elements that are well known to those skilled in the art and are not further described here. The output of the back plate 202 may be coupled to an integrated circuit (not shown) for further processing. The MEMS microphone 200 receives sound energy from the port 216, the sound energy moves the diaphragm 208, this movement causes a change in charge of the back plate 202, which creates an electrical signal. The electrical signal may be transmitted to an integrated circuit or out of the microphone 200.

In one example of the operation of the system of FIG. 2, particulates pass through the port 216 but cannot pass the diaphragm 208. The second opening 222 begins the manufacturing process as a normal-sized hole (e.g., sized at 10 um) since it is not used as a particulate filter. However, since the opening 220 can be greatly increased in size and this improves the signal-to-noise ratio. Consequently, a microphone 200 is provided that prevents debris from entering the sensitive region 218 or impacting the diaphragm 208, but the device 200 still has a significantly improved signal-to-noise ratio (e.g., 62 dBA)

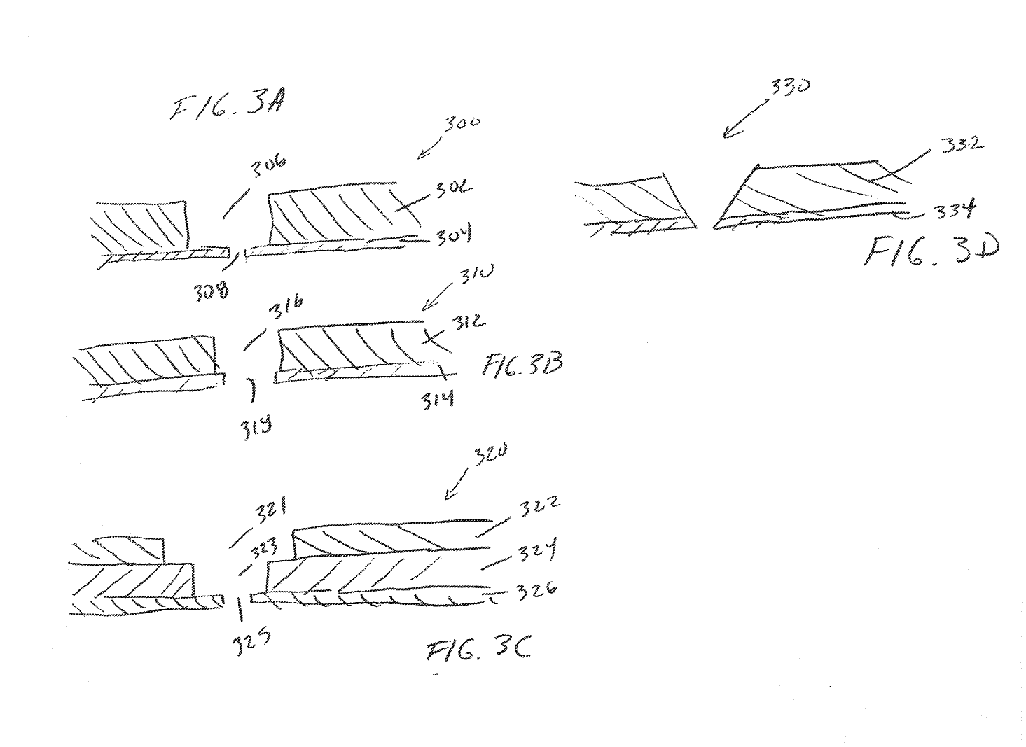

Referring now to FIGS. 3A-D, examples of back plate structures are described. In these examples the number of layers and profiles are altered. However, it will be appreciated that other number of layers and other profiles may be used.

Referring now to especially to FIG. 3A, a back plate 300 includes a first layer 302 (and first opening 306) and a second layer 304 (and a second opening 308). This is also a step structure where the second opening 308 is reduced to be substantially less in diameter than the first opening 306. In one aspect, this structure is used in a top port and particulates entering the opening 306 are prevented from passing through the opening 308.

Referring now to FIG. 3B, a back plate 310 includes a first layer 312 (with first opening 316) and a second layer 314 (with a second opening 318). This is a stepped structure. Manufacturing begins with a same size for hole opening 318, but then the size of the opening 316 is increased. Consequently, increasing the size of the opening 316 increases and improves the signal-to noise ratio and performance of the microphone where the back plate 310 is used.

Referring now to FIG. 3C, a back plate 320 includes a first layer 322 (with a first opening 321), a second layer 324 (with a second opening 323), and a third layer 326 (with a third opening 325). This is a stepped structure and the size of the openings 321, 323, and 325 may be adjusted so the size prevents particulate movement, or so that the opening sizes maximize the signal-to-noise ratio of the microphone.

Referring now to FIG. 3D, a back plate 330 includes a first layer 332 and a second layer 334. The profile of this structure is funnel-shaped and the exact dimensions can be adjusted to prevent debris entry, or to increase the signal-to-noise ratio.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic microphone, the microphone comprising:
a back plate;
a diaphragm;
a microelectromechanical system (MEMS) structure coupled to the back plate and the diaphragm, the MEMS structure disposed on a substrate;
wherein the back plate comprises a first layer and a second layer that are disposed in generally parallel relation to each other, the first layer including a first opening with a first sizing and the second layer including a second opening with a second sizing, the first sizing being different from the second sizing, the first opening and the second opening forming a channel through the back plate.

2. The microphone of claim 1 wherein the back plate includes a third layer with a third opening.

3. The microphone of claim 1 wherein the first sizing comprises a first diameter and the second sizing comprises a second diameter, and wherein the first diameter is less than the second diameter.

4. The microphone of claim 1 wherein the first layer and the second layer are constructed of a thin film material.

5. The microphone of claim 1 wherein the channel is step shaped.

6. The microphone of claim 1 wherein the channel is funnel shaped.

7. The microphone of claim 1 wherein the microphone is a top port device.

8. The microphone of claim 1 wherein the microphone is a bottom port device.

9. A back plate configured for use in a microelectromechanical system (MEMS) microphone, the back plate comprising:
a first layer; and
a second layer that are disposed in generally parallel relation to each other;
wherein the first layer comprises a first opening with a first sizing and the second layer includes a second opening with a second sizing, the first sizing being different from the second sizing, the first opening and the second opening forming a channel through the back plate.

10. The back plate of claim 9 further comprising a third layer with a third opening.

11. The back plate of claim 9 wherein the first sizing comprises a first diameter and the second sizing comprises a second diameter, and wherein the first diameter is less than the second diameter.

12. The back plate of claim 9 wherein the first layer and the second layer are constructed of a thin film material.

13. The back plate of claim 9 wherein the channel is step shaped.

14. The back plate of claim 9 wherein the channel is funnel shaped.
